(19) United States
(12) Patent Application Publication
(10) Pub. No.: US 2025/0118505 A1
(43) Pub. Date: Apr. 10, 2025

(54) Linkage Device for Electric Switch Assembly and Electric Switch Assembly Comprising the Linkage Device

(71) Applicant: ABB Schweiz AG, Baden (CH)

(72) Inventors: Antti Kultalahti, Vaasa (FI); Jarmo Lehtimäki, Vaasa (FI); André Nordman, Vaasa (FI)

(21) Appl. No.: 18/897,154

(22) Filed: Sep. 26, 2024

(30) Foreign Application Priority Data
Oct. 4, 2023 (EP) 23201529.7

(51) Int. Cl. H01H 9/26; H01H 21/30

(52) U.S. Cl. CPC H01H 9/26; H01H 21/30; H01H 2221/052; H01H 2221/064

(57) ABSTRACT

A linkage device adapted to control two electric switches including a main control shaft member, an actuation system including a first actuation member for actuating a control shaft of a first electric switch, and a second actuation member for actuating a control shaft of a second electric switch. A mechanism of the linkage device is provided with a torque limiting connection for each electric switch, wherein the torque limiting connection is adapted to disengage during an opening event if a torque exerted to an actuation member exceeds a predetermined limit value. The linkage device includes a stopping member system adapted to co-operate with a linkage arm system for preventing rotation of the main control shaft member to an OFF-position when the torque limiting connection of at least one linkage arm of the linkage arm system is in a disengaged position.

### TECHNICAL FIELD

The present invention relates to a linkage device for an electric switch assembly, and to an electric switch assembly comprising the linkagedevice.

### BACKGROUND

In many cases, an electric switch assembly is required to have a reliable position indication, which means that a main control shaft member of the electric switch assembly must be prevented to move into an OFF-position thereof if at least one pole of the electric switch assembly is not in a disconnected position.

A known multipole electric switch assembly comprises two electric switches and a linkage device adapted to control the two electric switches.

Herein, a multipole electric switch assembly is a six pole or eight pole assembly.

### SUMMARY

An object of the present invention is to provide a linkage device for a multipole electric switch assembly such that the linkage device has a reliable position indication. The objects of the invention are achieved by a linkage device described in the following.

The invention is based on the idea of providing a reliable position indication by means of torque limiting connections and a stopping member system. A mechanism of a linkage device is provided with a torque limiting connection for each electric switch, wherein the torque limiting connection is adapted to disengage during an opening event if a torque exerted to an actuation member exceeds a predetermined limit value, wherein the actuation member is a component adapted for actuating a control shaft of one of the electric switches. The stopping member system is adapted to prevent rotation of the main control shaft member to the OFF-position when at least one of the torque limiting connections is in a disengaged position.

An advantage of the linkage device of the invention is that the linkage device provides a reliable position indication.

### BRIEF DESCRIPTION OF THE DRAWINGS

In the following the invention will be described in greater detail by means of preferred embodiments with reference to the attached drawings, inwhich

FIG. 1 shows an electric switch assembly comprising a linkage device according to an embodiment of the invention and two electric switches connected to the linkage device;

FIG. 2 shows the electric switch assembly of FIG. 1 in a disassembled state;

FIG. 3 shows an exploded view of the linkage device of FIG. 1;

FIG. 4 shows a first linkage arm of the linkage device of FIG. 1;

FIG. 5A shows a mechanism of the linkage device of FIG. 1 in an OFF-state;

FIG. 5B shows the mechanism of the linkage device of FIG. 1 in an ON-state; and

FIG. 5C shows the mechanism of the linkage device of FIG. 1 in a situation where a stopping member system prevents rotation of a main control shaft member to an OFF-position.

### DETAILED DESCRIPTION

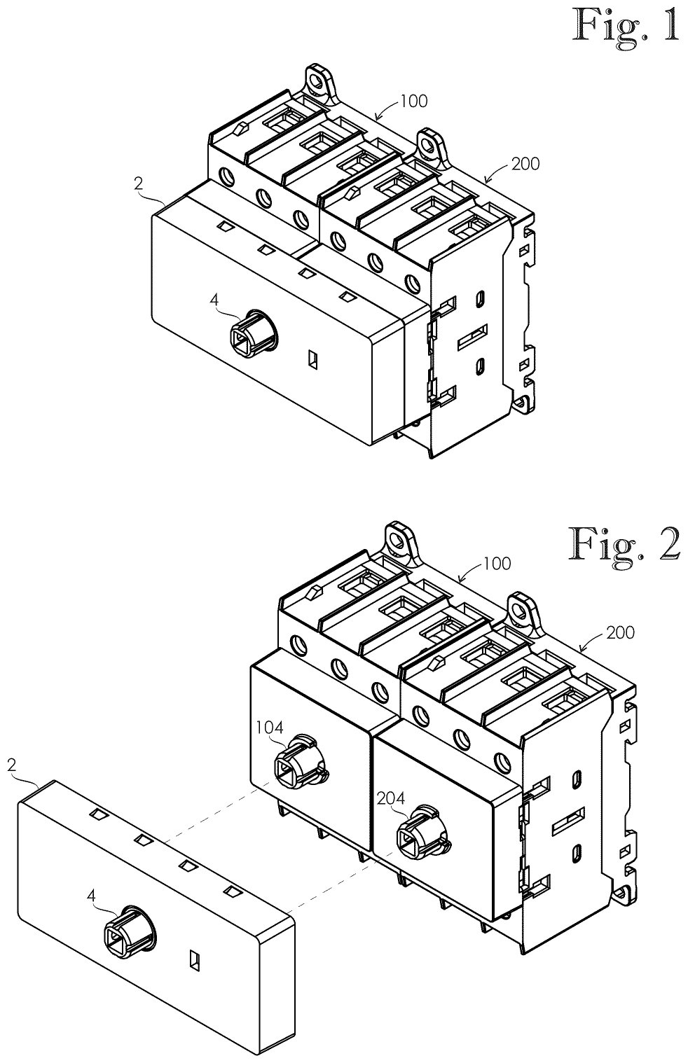

FIG. 1 shows an electric switch assembly comprising a linkage device, a first electric switch 100 and a second electric switch 200. The first electric switch 100 and the second electric switch 200 are located side by side and are connected to the linkage device.

FIG. 2 shows the electric switch assembly of FIG. 1 in a disassembled state. The linkage device comprises a frame 2, a main control shaft member 4 and an actuation system. The first electric switch 100 comprises a control shaft 104 rotatable between an ON-position and an OFF-position relative to a frame of the first electric switch. The second electric switch 200 comprises a control shaft 204 rotatable between an ON-position and an OFF-position relative to a frame of the second electric switch. Both the first electric switch 100 and the second electric switch 200 are three pole switches. The electric switch assembly is a six pole assembly.

The main control shaft member 4 is rotatable between an ON-position and an OFF-position relative to the frame 2. The main control shaft member 4 is adapted to be rotated from the ON-position to the OFF-position in an opening event. The main control shaft member 4 is adapted for controlling the control shaft 104 of the first electric switch 100 and the control shaft 204 of the second electric switch 200.

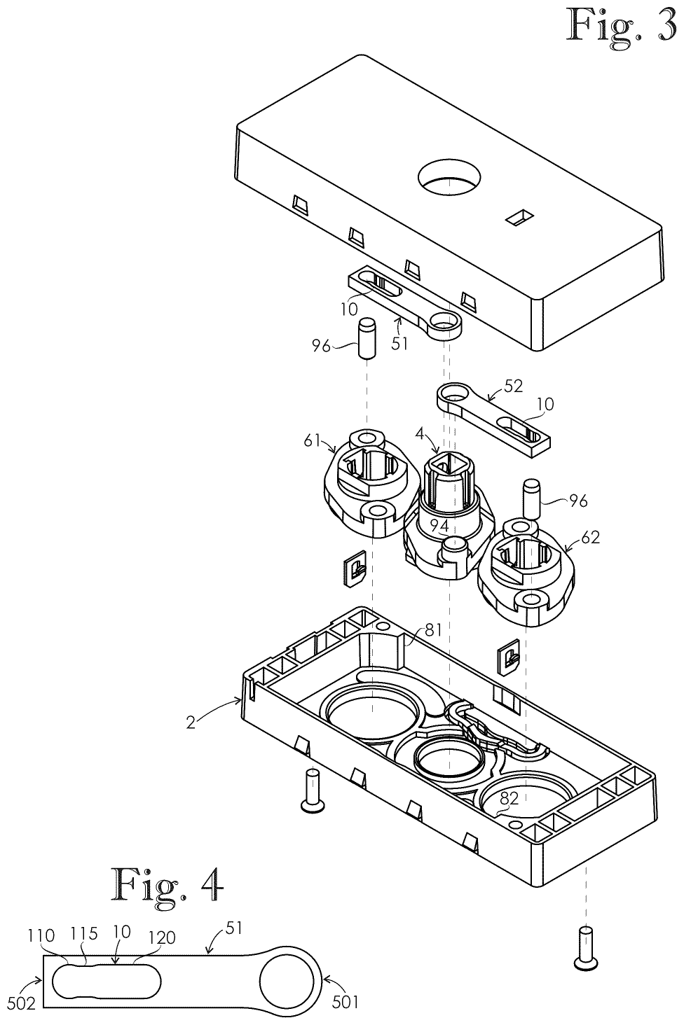

FIG. 3 shows an exploded view of the linkage device of FIG. 1. In addition to the actuation system, FIG. 3 shows a linkage arm system and a stopping member system of the linkage device.

The actuation system comprises a first actuation member 61 for actuating the control shaft 104 of the first electric switch 100, and a second actuation member 62 for actuating the control shaft 204 of the second electric switch 200.

Each of the first actuation member 61 and the second actuation member 62 is rotatable between a first position and a second position thereof relative to the frame 2. Rotation axes of the main control shaft member 4, the first actuation member 61 and the second actuation member 62 are parallel to each other. Further, the rotation axes of the main control shaft member 4, the first actuation member 61 and the second actuation member 62 are located on a same plane. The main control shaft member 4 is located between the first actuation member 61 and the second actuation member 62.

Each of the first actuation member 61 and the second actuation member 62 comprises a shaft aperture adapted to partially receive the control shaft of corresponding electric switch such that the actuation member is capable of rotating the received control shaft.

The linkage arm system mechanically connects the main control shaft member 4 to the first actuation member 61 and the second actuation member 62 such that in normal operating conditions of the linkage device, rotation of the main control shaft member 4 from the ON-position to the OFF-position moves the first actuation member 61 and the second actuation member 62 from their first positions to their second positions. The linkage arm system is adapted to transfer torque from the main control shaft member 4 to the first actuation member 61 and the second actuation member 62.

The linkage arm system comprises a first linkage arm 51 between the main control shaft member 4 and the first actuation member 61, and a second linkage arm 52 between the main control shaft member 4 and the second actuation member 62. The main control shaft member 4 is connected to each linkage arm with a corresponding drive pin 94 whose centre axis is stationary relative to both the main control shaft member 4 and the linkage arm. One of the drive pins rotatably connects the main control shaft member 4 and the first linkage arm 51, and the other drive pin rotatably connects the main control shaft member 4 and the second linkage arm 52.

There is a torque limiting connection both between the first linkage arm 51 and the first actuation member 61, and between the second linkage arm 52 and the second actuation member 62. The torque limiting connection is adapted to disengage during the opening event if a torque exerted to the actuation member by the linkage arm exceeds a predetermined limit value. Therefore, the torque limiting connection between the first linkage arm 51 and the first actuation member 61 is adapted to disengage during the opening event if a torque exerted to the first actuation member 61 by the first linkage arm 51 exceeds a predetermined limit value. Similarly, the torque limiting connection between the second linkage arm 52 and the second actuation member 62 is adapted to disengage during the opening event if a torque exerted to the second actuation member 62 by the second linkage arm 52 exceeds a predetermined limit value.

The predetermined limit value for the torque exerted to the actuation member by the linkage arm is 250% of a nominal torque required to actuate a control shaft of the corresponding electric switch. In an alternative embodiment, the predetermined limit value for the torque exerted to the actuation member by the linkage arm is greater than or equal to 150% of a nominal torque required to actuate a control shaft of the corresponding electric switch.

FIG. 4 shows the first linkage arm 51. The first linkage arm 51 has a first end 501 and a second end 502. An aperture adapted to receive the drive pin 94 is located adjacent to the first end 501.

The second linkage arm 52 is identical to the first linkage arm 51. Further, the first actuation member 61 is identical to the second actuation member 62.

The stopping member system is adapted to co-operate with the linkage arm system for preventing rotation of the main control shaft member 4 to the OFF-position when the torque limiting connection of at least one linkage arm of the linkage arm system is in a disengaged position relative to the corresponding actuation member. The stopping member system comprises a first stopping member 81 adapted to be in contact with the second end of the first linkage arm 51, and a second stopping member 82 adapted to be in contact with the second end of second linkage arm 52. The first stopping member 81 and the second stopping member 82 are stationary members relative to the frame 2. FIG. 3 shows that the first stopping member 81 and the second stopping member 82 protrude from inner walls of the frame 2.

In the embodiment shown in FIG. 3, the first stopping member 81 and the second stopping member 82 are integral parts of the frame 2, and they are formed with the same injection moulding process as the frame 2. In an alternative embodiment, the first stopping member and the second stopping member comprise separate components connected to the frame.

The torque limiting connection comprises an elongated groove 10 provided in the first linkage arm 51, and an actuation pin 96 connected to the first actuation member 61 and received in the elongated groove 10.

The linkage device comprises two actuation pins 96, one of which rotatably connects the main control shaft member 4 and the first linkage arm 51, and the other rotatably connects the main control shaft member 4 and the second linkage arm 52. Since a connection between the first linkage arm 51 and the first actuation member 61 is similar to a connection between the second linkage arm 52 and the second actuation member 62, only the connection between the first linkage arm 51 and the first actuation member 61 is discussed herein.

The actuation pin 96 is spaced apart from a rotation axis of the first actuation member 61, and extends parallel to the rotation axis of the first actuation member 61. A centre axis of the actuation pin 96 is stationary relative to the first actuation member 61.

The elongated groove 10 has a first section 110 and a second section 120 separated by a narrowing section 115. The elongated groove 10 extends linearly. The first section 110 of the elongated groove 10 is located farther from a connection between the main control shaft member 4 and the linkage arm than the second section 120 of the elongated groove 10. The first section 110 of the elongated groove 10 is located adjacent to the second end 502 of the first linkage arm 51.

In normal operating conditions, the actuation pin 96 is received in the first section 110 of the elongated groove 10. The torque limiting connection is adapted to disengage such that the actuation pin 96 moves from the first section 110 to the second section 120 through the narrowing section 115.

In a longitudinal direction of the first linkage arm 51, a dimension of the first section 110 of the elongated groove 10 is smaller than a dimension of the second section 120 of the elongated groove 10. The longitudinal direction of the first linkage arm 51 extends in a plane perpendicular to the rotation axis of the main control shaft member 4. In FIG. 4, the longitudinal direction of the first linkage arm 51 is a horizontal direction.

The actuation pin 96 has a circular cross section. The first section 110 of the elongated groove 10 is dimensioned to allow in the normal operating conditions of the linkage device a lateral movement of the actuation pin 96 in the first section 110 which is smaller than or equal to 10% of a diameter of the actuation pin 96. The lateral movement takes place in a plane perpendicular to the rotation axis of the main control shaft member 4. In another embodiment, the first section of the elongated groove is dimensioned to allow in the normal operating conditions of the linkage device a lateral movement of the actuation pin which is smaller than or equal to 25% of a diameter of the actuation pin.

In an alternative embodiment in which a cross section of the actuation pin is non-circular, the first section of the elongated groove is dimensioned to allow in the normal operating conditions of the linkage device a lateral movement of the actuation pin in the first section which is smaller than or equal to 10% of a maximum lateral dimension of the actuation pin. In a further alternative embodiment, the first section of the elongated groove is dimensioned to allow in the normal operating conditions of the linkage device a lateral movement of the actuation pin which is smaller than or equal to 25% of a maximum lateral dimension of the actuation pin. In a still further alternative embodiment, the first section of the elongated groove is dimensioned such that in the normal operating conditions, the lateral movement of the actuation pin is prevented except for movement caused by a clearance between the actuation pin and the first section of the elongated groove, wherein the clearance results from manufacturing techniques used to make the actuation pin and the elongated groove.

The second section 120 of the elongated groove 10 is dimensioned to allow in the disengaged position of the torque limiting connection a lateral movement of the actuation pin 96 which is greater than or equal to 50% of a diameter of the actuation pin 96. In an alternative embodiment in which a cross section of the actuation pin is non-circular, the second section of the elongated groove is dimensioned to allow in the disengaged position of the torque limiting connection a lateral movement of the actuation pin which is greater than or equal to 50% of the maximum lateral dimension of the actuation pin.

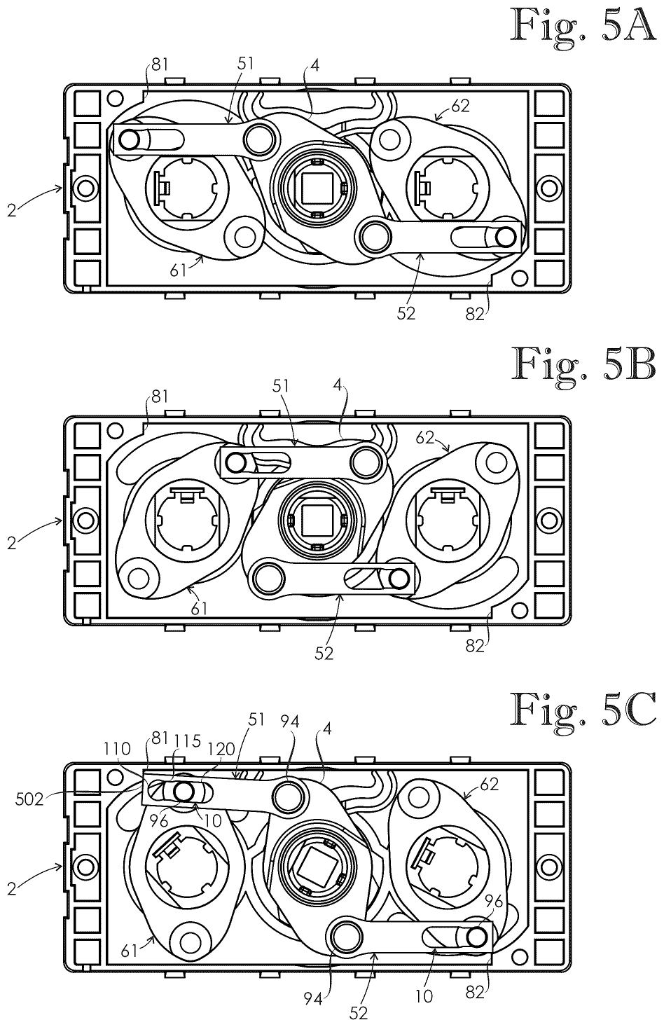

FIGS. 5A-5C illustrate operation of the mechanism of the linkage device. FIG. 5A shows the mechanism of the linkage device in an OFF-state. FIG. 5B shows the mechanism of the linkage device in an ON-state. FIG. 5C shows the mechanism of the linkage device in a situation where the torque limiting connection of the first linkage arm 51 is in the disconnected position relative to the first actuation member 61, and the second end 502 of the first linkage arm 51 is in contact with the first stopping member 81 thereby preventing rotation of the main control shaft member 4 to the OFF-position.

In FIG. 5A, the main control shaft member 4 is in the OFF-position, and the first actuation member 61 and the second actuation member 62 are in their second positions. One of the actuation pins 96 is in the first section 110 of the elongated groove 10 of the first linkage arm 51, and the other of the actuation pins 96 is in the first section 110 of the elongated groove 10 of the second linkage arm 52.

In FIG. 5B, the main control shaft member 4 is in the ON-position, and the first actuation member 61 and the second actuation member 62 are in their first positions. Each of the actuation pins 96 is in the first section 110 of the corresponding elongated groove 10, as in FIG. 5A.

Transition from the situation of FIG. 5A to the situation of FIG. 5B is realized by rotating the main control shaft member 4 ninety degrees clockwise. As a response to the rotation of the main control shaft member 4 ninety degrees clockwise, both the first actuation member 61 and the second actuation member 62 rotate ninety degrees clockwise.

In FIG. 5C, the main control shaft member 4 is in an intermediate position between the ON-position and the OFF-position, and the first actuation member 61 and the second actuation member 62 are in intermediate positions between their first and second positions. The intermediate positions of the first actuation member 61 and the second actuation member 62 are different from each other. One of the actuation pins 96 is in the second section 120 of the elongated groove 10 of the first linkage arm 51, and the other of the actuation pins 96 is in the first section 110 of the elongated groove 10 of the second linkage arm 52.

Transition from the situation of FIG. 5B to the situation of FIG. 5C is realized by rotating the main control shaft member 4 counterclockwise. An intension of an operator of the electric switch assembly has been to carry out the opening event by rotating the main control shaft member from the ON-position to the OFF-position. However, during the opening event, a torque exerted to the first actuation member 61 by the first linkage arm 51 has exceeded the predetermined limit value, and the torque limiting connection between the first actuation member 61 and the first linkage arm 51 has disengaged.

A width of the narrowing section 115 of the elongated groove 10 is smaller than the diameter of the actuation pin 96. Therefore, in order to allow the actuation pin 96 to pass through the narrowing section 115, at least one of the narrowing section 115 and the actuation pin 96 has to change its shape. In a typical embodiment, it is the narrowing section that deforms the most. The deformations of the narrowing section and the actuation pin are reversible deformations.

A length of the narrowing section 115 of the elongated groove 10 is small compared to a length of the second section 120 of the elongated groove 10. In an embodiment, a length of the narrowing section is in a range of 30-100% of a maximum lateral dimension of the actuation pin. In another embodiment, a length of the narrowing section is in a range of 1.5-5 mm. The length of the narrowing section is a dimension parallel to the direction in which the elongated groove extends.

There can be several reasons for the torque exerted to the first actuation member 61 by the first linkage arm 51 exceeding the predetermined limit value. One of the reasons is that at least one contact of the electric switch controlled by the first actuation member 61 has stuck due to welding caused by a short-circuit situation in the electric switch.

FIG. 5C shows that the main control shaft member 4 has stopped to a position thirty degrees from the OFF-position. In alternative embodiments, the stopping member system is adapted to co-operate with the linkage arm system for stopping the main control shaft member to an intermediate fault position located at least 10° from the OFF-position.

It will be obvious to a person skilled in the art that the inventive concept can be implemented in various ways. The invention and its embodiments are not limited to the examples described above but may vary within the scope of the claims.

1. Alinkage device for an electric switch assembly, comprising: a
frame;
a main control shaft member rotatable between an ON-position and an OFF-position relative to the frame, wherein the main control shaft member is adapted to be rotated from the ON-position to the OFF-position in an opening event;
an actuation system including a first actuation member for actuating a control shaft of a first electric switch, and a second actuation member for actuating a control shaft of a second electric switch, wherein each of the first actuation member and the second actuation member is rotatable between a first position and a second position thereof;
a linkage arm system mechanically connecting the main control shaft member to the first actuation member and the second actuation member such that in normal operating conditions of the linkage device, rotation of the main control shaft member from the ON-position to the OFF-position moves the first actuation member and the second actuation member from their first positions to their second positions, wherein the linkage arm system includes a first linkage arm between the main control shaft member and the first actuation member, and a second linkage arm between the main control shaft member and the second actuation member,
wherein there is a torque limiting connection both between the first linkage arm and the first actuation member, and between the second linkage arm and the second actuation member, wherein the torque limiting connection is adapted to disengage during the opening event if a torque exerted to the actuation member by the linkage arm exceeds a predetermined limit value,
wherein the linkage device includes a stopping member system adapted to co-operate with the linkage arm system for preventing rotation of the main control shaft member to the OFF-position when the torque limiting connection of at least one linkage arm of the linkage arm system is in a disengaged position relative to the corresponding actuation member.

2. The linkage device according to claim 1, wherein each linkage arm has a first end and a second end such that a connection between the main control shaft member and the linkage arm is located adjacent to the first end, and the stopping member system comprises a first stopping member adapted to be in contact with the second end of the first linkage arm, and a second stopping member adapted to be in contact with the second end of the second linkage arm, wherein the first stopping member and the second stopping member are stationary members relative to the frame.

3. The linkage device according to claim 1, wherein the torque limiting connection comprises an elongated groove provided in the linkage arm, and an actuation pin connected to the actuation member and received in the elongated groove, wherein the elongated groove has a first section and a second section separated by a narrowing section, wherein in normal operating conditions the actuation pin is received in the first section, and the torque limiting connection is adapted to disengage such that the actuation pin moves from the first section to the second section through the narrowing section.

4. The linkage device according to claim 3, wherein in a longitudinal direction of the linkage arm, a dimension of the first section of the elongated groove is smaller than a dimension of the second section of the elongated groove, wherein the longitudinal direction of the linkage arm extends in a plane perpendicular to the rotation axis of the main control shaft member.

5. The linkage device according to claim 4, wherein the first section of the elongated groove is dimensioned to allow in the normal operating conditions of the linkage device a lateral movement of the actuation pin which is smaller than or equal to 25% of a maximum lateral dimension of the actuation pin, and the second section of the elongated groove is dimensioned to allow in the disengaged position of the torque limiting connection a lateral movement of the actuation pin which is greater than or equal to 50% of the maximum lateral dimension of the actuation pin.

6. The linkage device according to claim 3, wherein the elongated groove provided in each linkage arm extends linearly.

7. The linkage device according to claim 3, wherein the first section of the elongated groove is located farther from a connection between the main control shaft member and the linkage arm than the second section of the elongated groove.

8. The linkage device according to claim 3, wherein disengagement of the torque limiting connection is realized by deformation of at least one of the narrowing section and the actuation pin, wherein said deformations are reversible deformations.

9. The linkage device according to claim 1, wherein a centre axis of each actuation pin is stationary relative to corresponding actuation member.

10. The linkage device according to claim 1, wherein the main control shaft member is connected to each linkage arm with a corresponding drive pin whose centre axis is stationary relative to both the main control shaft member and the linkage arm.

11. The linkage device according to claim 1, wherein rotation axes of the main control shaft member, the first actuation member and the second actuation member are parallel to each other.

12. The linkage device according to claim 1, wherein the stopping member system is adapted to co-operate with the linkage arm system for stopping the main control shaft member to an intermediate fault position located at least 10° from the OFF-position.

13. An electric switch assembly comprising a first electric switch, a second electric switch and the linkage device having:
a frame;
a main control shaft member rotatable between an ON-position and an OFF-position relative to the frame, wherein the main control shaft member is adapted to be rotated from the ON-position to the OFF-position in an opening event;
an actuation system including a first actuation member for actuating a control shaft of a first electric switch, and a second actuation member for actuating a control shaft of a second electric switch, wherein each of the first actuation member and the second actuation member is rotatable between a first position and a second position thereof;
a linkage arm system mechanically connecting the main control shaft member to the first actuation member and the second actuation member such that in normal operating conditions of the linkage device, rotation of the main control shaft member from the ON-position to the OFF-position moves the first actuation member and the second actuation member from their first positions to their second positions, wherein the linkage arm system includes a first linkage arm between the main control shaft member and the first actuation member, and a second linkage arm between the main control shaft member and the second actuation member,
wherein there is a torque limiting connection both between the first linkage arm and the first actuation member, and between the second linkage arm and the second actuation member, wherein the torque limiting connection is adapted to disengage during the opening event if a torque exerted to the actuation member by the linkage arm exceeds a predetermined limit value,
wherein the linkage device includes a stopping member system adapted to co-operate with the linkage arm system for preventing rotation of the main control shaft member to the OFF-position when the torque limiting connection of at least one linkage arm of the linkage arm system is in a disengaged position relative to the corresponding actuation member.

14. The electric switch assembly according to claim 13, wherein the predetermined limit value for the torque exerted to the actuation member by the linkage arm is greater than or equal to 150% of a nominal torque required to actuate a control shaft of the corresponding electric switch.
